(19) United States
(12) Patent Application Publication
(10) Pub. No.: US 2005/0242133 A1
(43) Pub. Date: Nov. 3, 2005

(54) Pedal-operated fluid dispensing apparatus

(76) Inventor: William A. Ward, Norwalk, CT (US)

Correspondence Address: GRIMES & BATTERSBY, LLP, 488 MAIN AVENUE, THIRD FLOOR, NORWALK, CT, 06851, US

(21) Appl. No.: 10/823,890

(22) Filed: Apr. 14, 2004

(51) Int. Cl. B65B 1/20; A01C 1/00

(52) U.S. Cl. 222/610

(57) ABSTRACT

A fluid dispensing apparatus integrated within a pedal operated vehicle such as bicycles, tricycles, three-wheelers, four-wheelers and paddleboats is provided comprising a means for storing a fluid, such as water, a means for pressurizing said stored fluid, a means for controlling the release of said pressurized fluid in the form of one or more jets. In the preferred embodiment, the fluid is stored within one or more tanks or reservoirs, which tanks include a pump mechanism for pressurizing the tanks and the fluid stored therein. The pump mechanism includes pistons which are connected to the pedal cranks of the vehicle such that operation of the pedals so as to propel the vehicle simultaneously serves to reciprocate the pistons of the pump mechanism, thereby pressurizing the fluid tanks. Connected to the fluid storage tanks is at least one conduit or hose which is connected at its opposite end to a nozzle for dispensing the fluid. A trigger is incorporated with said nozzle so as to allow the user to alternatively release the pressurized fluid or stop the flow of said fluid. The nozzle may be incorporated on the handlebars or steering mechanism of the vehicle such that the fluid is released in the direction the vehicle is facing. A safety valve is also provided for the storage tanks to prevent the generation of dangerous pressure level.

### BACKGROUND OF THE INVENTION

1. Field of the Invention

The present invention relates generally to pedal-driven vehicles, both terrestrial and aquatic, such as bicycles, three-wheelers, four wheelers and paddleboats, and, more particularly, to pedal-driven vehicles including one or more water pumps coupled to the pedaling means, wherein the water pumps are in turn connected to one or more squirt guns attached to the handlebars or steering mechanism of the vehicle, allowing the operator of the vehicle to shoot water at targets in front of the vehicle, or alternatively at any target within range.

2. Description of the Prior Art

The prior art fails to specifically address either the problem or the solution arrived upon by applicant. Squirt guns and water pistols have long been known in the prior art, with high-powered “turbo soak” water guns including large reservoirs to hold the water and having pump action mechanism for building up air pressure in the reservoir, becoming a popular variation of the basic squirt gun in recent years.

For example, Larami Limited, located in Mt. Laurel, N.J., owns a number of utility and design patents for high powered water guns having one, two or even three pressurized reservoirs or tanks. Larami's utility patents include U.S. Pat. Nos. 5,222,531; 5,702,283; 6,012,609; 6,138,871; 6,193,107; 6,345,732; 6,364,291; and 6,631,830. Their design patents cover a number of different configurations for these guns, and include U.S. Pat. Nos. D336,668; D336,938; D336,939; D338,697; D423,063; D423,609; D426,592; D426,593; D427,251; D428,077; D433,079; D478,639; and D479,286.

Of course, pedaled bicycles have been around since the mid-1800s, and other pedaled vehicles, including tricycles and paddle boats have long been known. Even the three-wheeled toy cycles having large rear wheels, such as the “Big Wheel”® children's toy have been known for decades, and new variations thereof are constantly being developed, such as, for example, U.S. Pat. No. 6,371,501, which issued to Jenkins on Apr. 16, 2002 for “Tread wheel frame system.” The patent to Jenkins describes a human-powered cycle having a tread wheel driving a tread rather than driving a drive wheel hub.

It is also well known to incorporate a water pistol or gun in connection with a pedaled vehicle. Many of these devices comprise a separate water pistol apparatus that is designed to be attached to an existing bicycle. For example, U.S. Pat. No. 6,196,474, which issued to Hillerson on Mar. 6, 2001 for “Pressurized cyclist water spraying apparatus” discloses a pressurized cycling water spraying apparatus adapted to be mounted on a cycling device having at least one rotating wheel, including a reservoir, an electric generator adapted to generate electric power from the rotation of the wheel, and an electric pump powered by the electric generator and adapted to pressurize the interior of the reservoir by a flow of air from the pump through an air tube and into the reservoir. Similarly, U.S. Pat. No. 5,735,440, which issued to Regalbuto on Apr. 7, 1998 for “Bicycle mounted squirt gun and fluid dispensing apparatus” discloses a squirt gun mounted to and supported by any of numerous sizes and styles of bicycles, the apparatus including a one or a plurality of serially connected pressurized water reservoir assemblies, a dual piston-in-cylinder water pump assembly, a manually operated water pump lever assembly, an assembly of multiple independent, manually-activated triggers, and multiple independently aimable nozzles.

Other examples of these vehicle mounted water guns are shown in U.S. Pat. No. 4,807,813, which issued to Coleman on Feb. 28, 1989 for “Bicycle mounted water toy,” disclosing an amusement device adapted to be mounted to a bicycle having a fluid reservoir, a pump driven by the bicycle wheel for removing fluid from the reservoir, a conduit for conveying water from the pump to an exit nozzle and a helmet adapted to be worn by the rider of the velocipede to which the nozzle can be attached; and U.S. Pat. No. 3,677,446, which issued to Guyer, Jr. et al. on Jul. 18, 1972 for “Liquid gun for use on wheeled vehicle,” disclosing a water gun for use on a bicycle or tricycle vehicle in which a pump driven by a roller engageable wheel of the vehicle drives a pump to pump water from a container through a nozzle.

A variation of these automatic water dispensing apparatuses are those devices designed to deliver water to a cyclist for drinking. For example, U.S. Pat. No. 4,815,635, which issued to Porter on Mar. 28, 1989 for “Cyclist water supply apparatus” discloses a water supply apparatus utilized in conjunction with a bicycle to enable a rider to receive either a spray of cooling water or a stream for drinking purposes having a diaphragm-type pump to supply the water and plural reservoirs to enable a plurality of liquids to be transported and utilized, such as water for cooling the rider and a sucrose solution for energy. Similarly, U.S. Pat. No. 5,326,124, which issued to Allemang on Jul. 5, 1994 for “Bicycle water delivery apparatus,” discloses a water delivery apparatus which may be mounted on a bicycle in which water may be delivered to be sprayingly discharged through the sprayer or to a mouthpiece which may be placed in a bicycle rider's mouth to allow water to be discharged directly therein. This apparatus operates with an existing standard water bottle for a bicycle and alleviates the possibility of having a stream of water misdirected, distracting the rider, nor will a rider be caught off-guard receiving a stream of water in the face when a spray was anticipated.

Another variation on the synthesis of hydraulics and pedaled vehicles is shown in U.S. Pat. No. 5,772,225, which issued to Brackett on Jun. 30, 1998 for “Hydraulic bicycle with conjugate drive motors” which discloses a device for transmitting power between mechanical movements including a fluid pump coupled to a first mechanical movement for pumping a fluid, a fluid motor coupled to a second mechanical movement and a manifold connecting the fluid pump and the fluid motor capable of conducting fluid output from the fluid pump to the fluid motor to drive the fluid motor and recirculate the fluid back to said fluid pump. The power transmission of this device is suitable for use on a bicycle replacing the typical gears and chain and preferably includes a shunt to permit the motor to override the pump, an apportionment valve to control the ratio of movement between a first and second mechanical movement, and a brake valve for stopping the second mechanical movement. Alternatively, the incorporation of pneumatics with pedaled vehicles is shown in U.S. Pat. No. 5,397,144, which issued to Mirand, et al. on Mar. 14, 1995 for “Bicycle operated air pump” which discloses an air pump for use with a chain-driven bicycle comprising a pair of opposed cylinders and a double-ended piston rod mounted in a housing. The lower run of the bicycle drive chain engages a drive sprocket of the pump assembly, and the resulting movement of the chain over the drive sprocket of the pump rotates the drive sprocket, which reciprocates a double-ended piston rod in the cylinders, and pumps air to an article to be inflated, such as the bicycle tire.

A pressurization device may be integrated within a bicycle, as is described in U.S. Pat. No. 5,143,390, which issued to Goldsmith on Sep. 1, 1992 for “Pressurization apparatus for cycle mounted accessories” and discloses a pressure chamber formed within one or more of the hollow tubular members of a cycle frame. Pressurized fluid or gas, such as air, is supplied from the pressure chamber by conduits through a pressure regulator and a control valve to a cycle mounted accessory, such as a pressurized fluid container or an inflatable seat. Alternatively, air pressure may be used to propel a bicycle, as is described in U.S. Pat. No. 4,568,097, which issued to Farooq on Feb. 4, 1986 for “Turbo air motor for bicycles” and discloses a bicycle drive means comprising a bicycle having a main frame and air passageway throughout a substantial portion of the main frame, an air intake means in fluid communication with the air passageway, an air compressor engaged with the front sprocket assembly of the bicycle and in fluid communication with the air passageway of the main frame for directing air flow into the main frame, a hollow rear frame member engaged with the main frame and the rear wheel of the bicycle for receiving the air flow from the main frame passageway and a turbine directly engaged with the rear axle of the bicycle and in fluid communication with the hollow rear frame member whereby driving forces imparted to the bicycle provide air flow from the air intake to the turbine.

As will be appreciated, the prior art does not even address the problem faced by applicant let alone offer the solution proposed herein.

### SUMMARY OF THE INVENTION

Against the foregoing background, it is a primary object of the present invention to provide a fluid dispensing apparatus that may be integrated with a pedal operated vehicle.

It is another object of the present invention to provide such a fluid dispensing apparatus which includes a pressurization chamber wherein the fluid is stored, said chamber being pressurized by the operation of the pedals.

It is still another object of the present invention to provide such a fluid dispensing apparatus that may include one or more fluid dispersal units or jets, said jets being either fixed or independently aimable and operable by a trigger.

It is yet another object of the present invention to provide such a fluid dispensing apparatus that may be easily operable by the user while simultaneously operating the vehicle itself.

It is another object of the present invention to provide such a fluid dispensing apparatus that provides both transportation and entertainment value.

It is another object of the present invention to provide such a fluid dispensing apparatus that may take a variety of different shapes or configurations wherein propulsion is provided by the operation of the pedals.

It is yet another object of the present invention to provide such a fluid dispensing apparatus that is easy to operate.

It is but another object of the present invention to provide such a fluid dispensing apparatus that includes one or more fluid chambers for the storage of a large quantity of fluid.

To the accomplishments of the foregoing objects and advantages, the present invention, in brief summary, comprises a fluid dispensing apparatus integrated within a pedal operated vehicle such as bicycles, tricycles, three-wheelers, four-wheelers and paddleboats. The apparatus itself comprises a means for storing a fluid, such as water, a means for pressurizing said stored fluid, a means for controlling the release of said pressurized fluid in the form of one or more jets. In the preferred embodiment, the fluid is stored within one or more tanks or reservoirs, which tanks include a pump mechanism for pressurizing the tanks and the fluid stored therein. The pump mechanism includes pistons which are connected to the pedal cranks of the vehicle such that operation of the pedals so as to propel the vehicle simultaneously serves to reciprocate the pistons of the pump mechanism, thereby pressurizing the fluid tanks. Connected to the fluid storage tanks is at least one conduit or hose which is connected at its opposite end to a nozzle for dispensing the fluid. A trigger is incorporated with said nozzle so as to allow the user to alternatively release the pressurized fluid or stop the flow of said fluid. The nozzle may be incorporated on the handlebars or steering mechanism of the vehicle such that the fluid is released in the direction the vehicle is facing, or, alternatively, the nozzle may disposed elsewhere on the vehicle. In the preferred embodiment, however, the nozzle and trigger are both situated on the steering mechanism. A safety valve is also provided for the storage tanks to prevent the generation of dangerous pressure levels.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a perspective view of the mechanical elements of the fluid dispensing apparatus of the present invention.

FIG. 2 is a top plan view of the fluid dispensing apparatus of the present invention.

FIG. 3 is a perspective view of the fluid dispensing apparatus of the present invention showing the pedal-operated components thereof.

FIG. 4 is another perspective view of the fluid dispensing apparatus of the present invention showing the pedal-operated components, including the piston element.

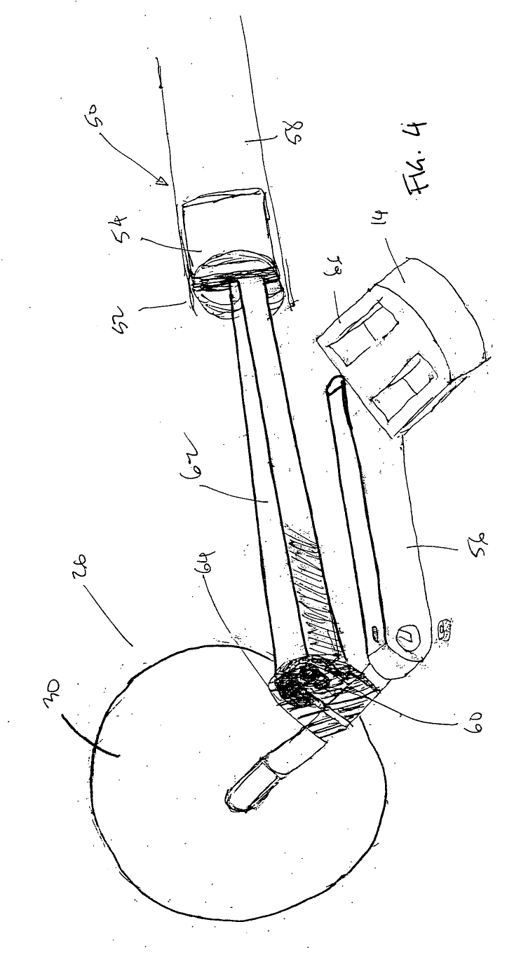

FIG. 5 is a top plan view of the components shown in FIG. 3.

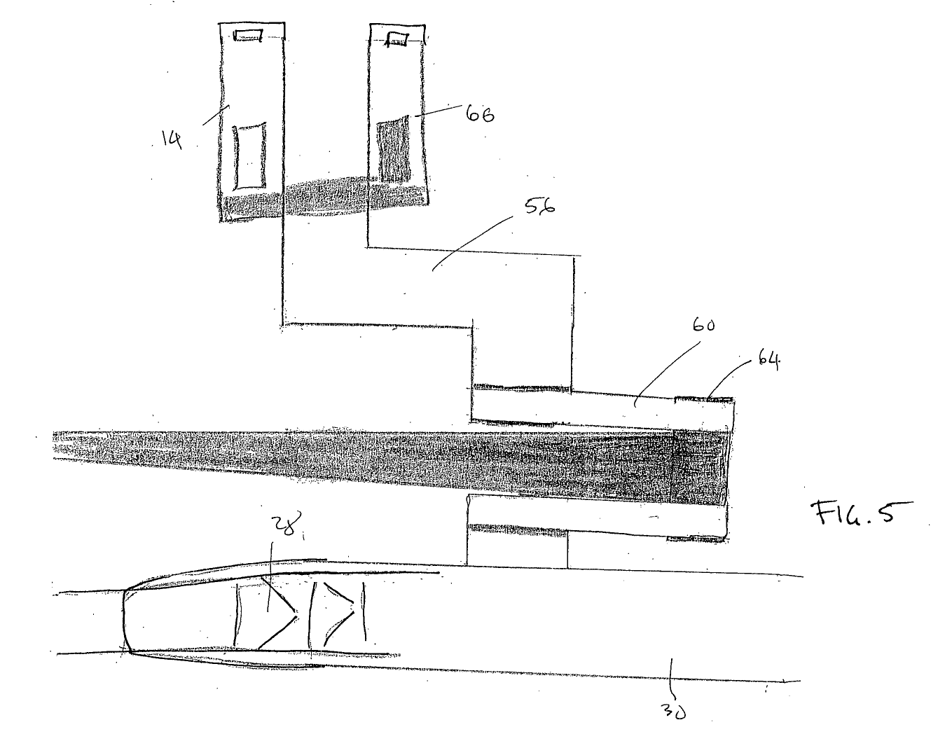

### DETAILED DESCRIPTION OF THE INVENTION

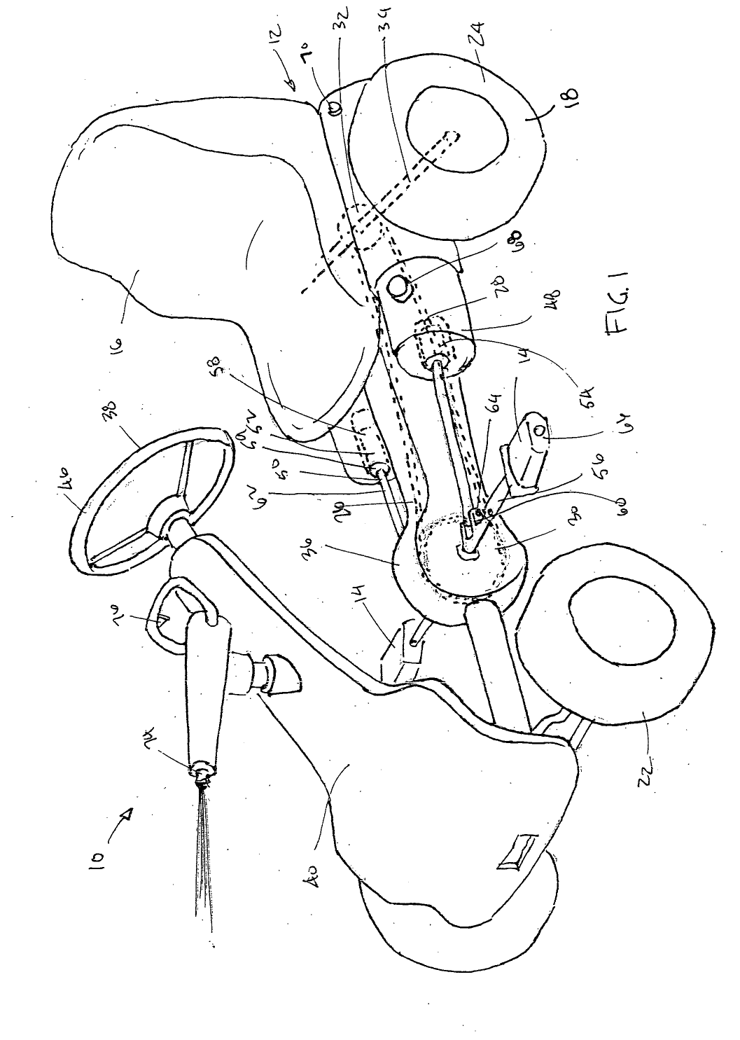

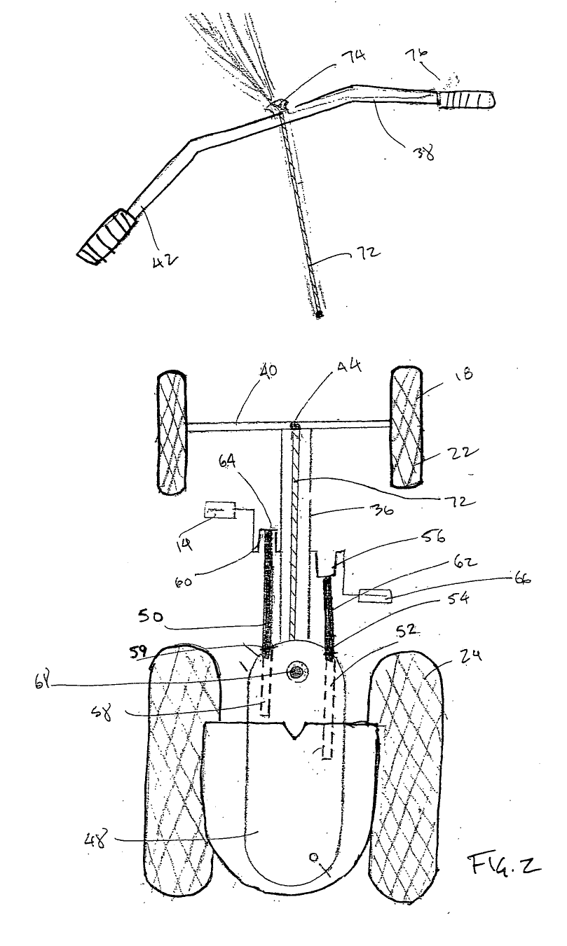

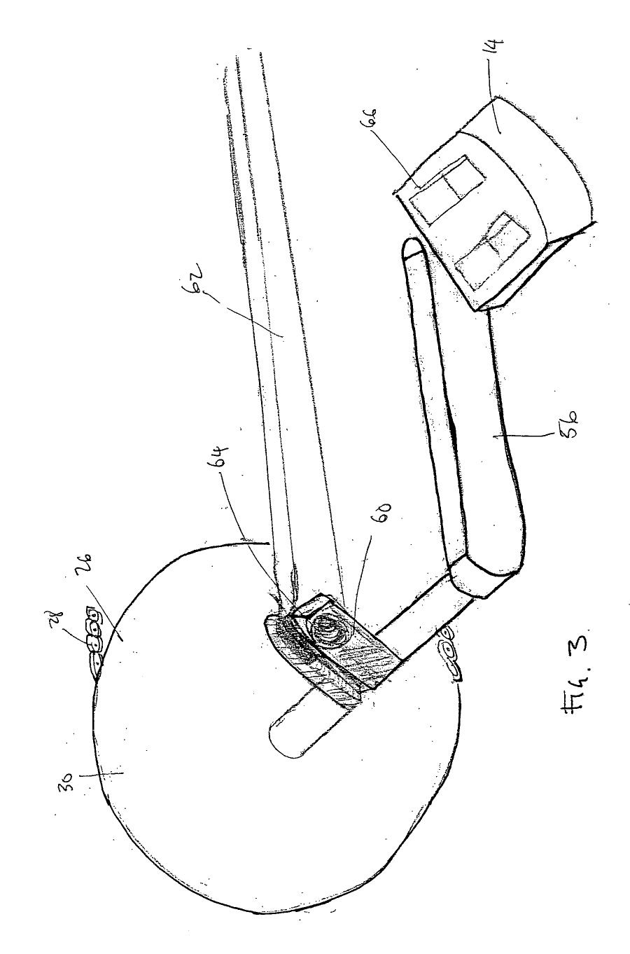

Referring to the drawings and, in particular, to FIGS. 1 and 2 thereof, the fluid dispensing apparatus of the present invention, referred to generally by reference numeral 10, is illustrated. The fluid dispensing apparatus 10 comprises a vehicle body 12 and at least one pair of pedals 14, said pedals 14 serving to propel the vehicle body 12 over land or across the water. In the preferred embodiment, a seat 16 is provided for the user, said seat 16 being situated so as to allow the user to comfortably operate the pedals 14. In the embodiment shown in FIGS. 1-3, the fluid dispensing apparatus 10 is shown in the configuration of a four-wheeler. It should be appreciated, however, that a variety of different configurations are contemplated, including that of a bicycle, a tricycle, a three-wheeler or a paddleboat. In the terrestrial embodiments, at least two tires 18 a provided for allowing the apparatus 10 to move over land. In the aquatic embodiment, at least one set of paddles 20 would be used in place of the tires 18.

The four-wheeler embodiment shown in FIGS. 1-2 includes a pair of front tires 22 and a pair of rear tires 24. Depending upon the configuration desired, of course, the number of front tires 22 and rear tires 24 may be varied. It is even conceivable that vehicles having more than four tires could be designed, perhaps capable of carrying multiple passengers.

In the preferred embodiment, the operation of the pedals 14 serves to provide rotational force to one or more of the tires 18, which in turn serves to propel the apparatus 10. In such embodiment, power from the pedals 14 is transmitted to the tires 18 by force transmission means 26. In the embodiment shown in FIGS. 1-3, the force transmission means 26 comprises a chain 28 connected to a front sprocket wheel 30 connected to said pedals 14, and to a rear sprocket wheel 32 connected to the axle 34 that interconnects and supports the rear tires 24. In this embodiment, the front and rear sprocket wheels 30, 32 and the chain 28 are housed and secured within a protective housing 36 which forms part of the vehicle body 12.

Of course, other means for transferring energy from the pedals 14 to the tires 18 exist, including belts, discs, clutches, gears, spurs, screws and worm drives. Likewise, the pedals 14 may be connected directly to a single front tire 22, as is the case with a tricycle, in which event no force transmission means 26 would be necessary. It should also be appreciated that the pedals 14 need not be required to power the apparatus 10—an electric or fuel-driven motor may also be utilized with equal effect.

Direction of travel may be controlled by the operator of the apparatus 10 using a steering control mechanism 38 which is integrated with said vehicle body 12. In the preferred embodiment, the steering control mechanism 38 comprises a front section 40 including the front tires 22 and handlebars 42 pivotally attached to the remainder of the vehicle body 12 at a pivot point 44. By turning the handlebars 42, and in turn the front section 40, relative to the pivot point 44, a user can control the direction of the apparatus 10 while in motion or when stationary.

Alternative means for steering the apparatus 10 are also contemplated, including a steering wheel 46 interconnected to said front tires 22 by means of a direct linkage or other means, such as a rack and pinion or cabling system.

Also incorporated within the vehicle body 12 is at least one pressurizable waterproof holding tank 48 for receiving and storing a fluid such as water. Pressurizing means 50 is provided for pressurizing the fluid stored within the tank 48. In the preferred embodiment, pressurizing means 50 comprises a pump mechanism 52 including pistons 54 which are connected to the pedal crank 56 portion of the pedals 14 such that operation of the pedals 14 simultaneously serves to reciprocate the pistons 54 within piston chambers 58 having at least one valve 59 therein for allowing air to be drawn in while preventing air from escaping, thereby pressurizing the holding tank 48 by pumping air into the tank 48. In the preferred embodiment, separate U-shaped members 60 are incorporated as part of the left and right pedal cranks 56 and the pistons 54 are attached to the bases of these U-shaped members 60 by means of rods 62 connected to the pistons 54 at one end and at bearings 62 on the pedal cranks 56 at the other end, as illustrated in FIG. 2. The U-shaped members 60 are disposed close to the front sprocket wheel 30 so as to prevent contact between the user and rods 62 and pistons 54 during operation. Of course, the pistons 54 may also be attached immediately adjacent to the foot pedal 66 portion of the pedals 14, although this would probably interfere with the operation of the pedals 14. In order to further prevent unwanted contact with the pistons 54 or rods 62, the U-shaped members 60, rods 62, and pistons 54 may also be housed within the protective housing 36.

Access to the interior of the fluid holding tank 48 is provided by means of an airtight plug 68, such as a screw-on cap with a rubber gasket, to allow the tank 48 to be filled with a fluid, such as by a water hose. Also provided on the holding tank 48 is at least one safety valve 70 designed to release air from the pressurized tank 48 at a predetermined pressure level. The safety valve 70 is designed to prevent the excess buildup of pressure within the tank 48 to dangerous levels or to levels that may compromise the integrity of the tank 48.

It should also be appreciated that other means for pressurizing the tanks 48 are contemplated, such as by means of an electronic pump. Airtight gaskets may be used to prevent the escape of any air or fluid from the tanks 48.

Connected to the fluid holding tank 48 is at least one conduit or hose 72, which hose is connected at one end to the tank 48 by means of an airtight/watertight seal. The other end of the hose 72 terminates in a nozzle 74 for dispensing the fluid. In the preferred embodiment, the hose 72 is a flexible plastic or rubber hose that extends through the vehicle body 12 and the front section 40 up to the steering control mechanism 38. The hose 72 must be sufficiently flexible and be of sufficient length so as to be able to flex in response to the turning of the front section 40 relative to the remainder of the vehicle body 12 when the apparatus 10 is being turned. Stays or clips may be provided at various points along the length of the hose 72 so as to keep it in place.

In the preferred embodiment, the nozzle 74 is situated in the middle of the handlebars 42 and point straight ahead, such that the fluid is dispersed therefrom in the direction the apparatus 10 is headed. The nozzle 74 may be adjustable so as to vary the stream or spray of fluid that is dispensed therefrom, such as a fine, long distance jet or a broad spray. Also in the preferred embodiment a trigger 76 is incorporated with said nozzle 74 so as to allow the user to alternatively release the pressurized fluid or stop the flow of said fluid. While in the preferred embodiment the nozzle 74 is be incorporated on the handlebars or steering mechanism of the vehicle such that the fluid is released in the direction the apparatus 10 is facing, alternatively, the nozzle 74 may disposed elsewhere on the vehicle. For example, if the apparatus 10 were designed to simulate the appearance of a fire truck, the nozzle 74 and hose 72 may be made to appear as a toy fire hose at the end of a movable ladder. Alternatively, the nozzle 74 may be removable, allowing the user to pick up the nozzle 74 as a water gun and aim it at the desired target. In such embodiment, there should be enough hose 72 to allow the nozzle 74 to be moved about easily.

Multiple tanks 48 may also be provided, each tank 48 providing pressurized fluid to a separate nozzle 74 and trigger 76 assembly, or, alternatively, both tanks 48 may be connected to the same nozzle 74 and trigger 76.

Having thus described the invention with particular reference to the preferred forms thereof, it will be obvious that various changes and modifications can be made therein without departing from the spirit and scope of the present invention as defined by the appended claims.

1. A fluid dispensing apparatus integrated with a vehicle having pedal-operated propulsion means, said apparatus comprising:
means for storing said fluid;
means for pressurizing said stored fluid, said means for pressurizing being connected to said pedal-operated propulsion means; and
means for controlling the release of said pressurized fluid in the form of one or more jets.

2. The fluid dispensing apparatus of claim 1, wherein said means for storing said fluid comprises at least one pressurizable tank.

3. The fluid dispensing apparatus of claim 2, wherein said pressurizable tank includes at least one safety valve for regulating the pressure of said tank.

4. The fluid dispensing apparatus of claim 3, wherein said tank comprises a water-tight chamber and includes a pneumatic pump mechanism for pressurizing the tanks and the fluid stored therein.

5. The fluid dispensing apparatus of claim 4, wherein said pump mechanism comprises at least one piston connected to said pedal-operated propulsion means such that operation of said pedal-operated propulsion means serves to simultaneously propel said apparatus and reciprocate the pistons of said pump mechanism, thereby pressurizing said fluid tanks.

6. The fluid dispensing apparatus of claim 1, further including at least one conduit connecting said storage means and said means for controlling the release of said fluid.

7. The fluid dispensing apparatus of claim 6, wherein said conduit comprises a flexible hose.

8. The fluid dispensing apparatus of claim 1, wherein said means for controlling the release of said fluid comprises a nozzle.

9. The fluid dispensing apparatus of claim 8, further including a trigger integrated with said nozzle, said trigger being adapted to alternatively release said pressurized fluid and stem the flow of said pressurized fluid.

10. The fluid dispensing apparatus of claim 9, wherein said vehicle includes a steering mechanism, and wherein said nozzle and said trigger are incorporated on said steering mechanism.

11. The fluid dispensing apparatus of claim 1, wherein said apparatus comprises a vehicle having at least one seat incorporated therein.

12. The fluid dispensing apparatus of claim 11, wherein said vehicle includes at least one front tire and at least one back tire and is adapted to traverse terrain.

13. The fluid dispensing apparatus of claim 12, wherein said pedal-operated propulsion means comprises a pair of pedals connected by means of a chain to at least one of said tires.

14. The fluid dispensing apparatus of claim 11, wherein said vehicle is configured in the shape of a boat and is adapted to float on water, and further including at least one rotatable set of paddles.

15. The fluid dispensing apparatus of claim 14, wherein said pedal-operated propulsion means comprises a pair of pedals connected by means of a chain to said set of paddles.

16. A fluid dispensing apparatus integrated with a vehicle having pedal-operated propulsion means, said apparatus comprising:
means for storing said fluid comprising at least one pressurizable tank including at least one safety valve for regulating the pressure of said tank, wherein said tank comprises a water-tight chamber;
means for pressurizing said stored fluid, said means for pressurizing being connected to said pedal-operated propulsion means, wherein said means for pressurizing comprises at least one pneumatic pump mechanism having at least one piston connected to said pedal-operated propulsion means such that operation of said pedal-operated propulsion means serves to simultaneously propel said apparatus and reciprocate the pistons of said pump mechanism, thereby pressurizing said fluid tanks;
at least one conduit connecting said storage means and said means for controlling the release of said fluid; and
means for controlling the release of said pressurized fluid in the form of one or more jets, said means for controlling the release of said fluid comprising a nozzle and a trigger adapted to alternatively release said pressurized fluid and stem the flow of said pressurized fluid.
